(19) United States
(12) Patent Application Publication
(10) Pub. No.: US 2007/0050095 A1
(43) Pub. Date: Mar. 1, 2007

(54) Controller area network based self-configuring vehicle management system and method

(75) Inventors: Kevin E. Nelson, Osceola, WI (US); Timothy B. Cleveland, Chisago, MN (US)

Correspondence Address: BAKER & DANIELS LLP, 300 NORTH MERIDIAN STREET, SUITE 2700, INDIANAPOLIS, IN, 46204, US

(73) Assignee: Polaris Industries Inc., Medina, MN (US)

(21) Appl. No.: 11/218,163

(22) Filed: Sep. 1, 2005

(51) Int. Cl. G06F 17/00

(52) U.S. Cl. 701/1

(57) ABSTRACT

A vehicle management system includes a first module having a plurality of functions. The vehicle management system also includes a second module and a system bus. At least the first module and the second module communicate on the system bus. The vehicle management system further includes an identifier based on one of a plurality of vehicle types. When a first vehicle type is identified, a first set of the plurality of functions is utilized based on the identifier associated with the first vehicle type. When a second vehicle type is identified, a second set of the plurality of functions is utilized based on the identifier associated with the second vehicle type.

### FIELD

The present teachings relate to a vehicle management system and more particularly relate to a controller area network based vehicle management system for utility and recreational vehicles that self-configures based on a type of vehicle.

### BACKGROUND

Some recreational and utility vehicles have relatively simple electronic controls for vehicle and engine management. Some electronic controls may include an engine computer that receives signals from a plurality of sensors. The signals may be indicative of respective operating states, temperatures, pressures, etc. throughout the vehicle. Each sensor may require one or more individual wires to connect with the engine computer. A large amount of sensors, thus a large amount of wires, typically requires relatively complex thus costly components, for example, wiring harnesses and engine computers. Changing the configuration of the electronic controls, whether during development or maintenance, may require complex thus costly changes to the components.

### SUMMARY OF THE INVENTION

The present teachings generally include a vehicle management system that includes a first module having a plurality of functions. The vehicle management system also includes a second module and a system bus. At least the first module and the second module communicate on the system bus. The vehicle management system further includes an identifier based on one of a plurality of vehicle types. When a first vehicle type is identified, a first set of the plurality of functions is utilized based on the identifier associated with the first vehicle type. When a second vehicle type is identified, a second set of the plurality of functions is utilized based on the identifier associated with the second vehicle type.

Further areas of applicability of the present teachings will become apparent from the detailed description provided hereinafter. It should be understood that the detailed description and specific examples, while indicating the various embodiments of the present teachings, are intended for purposes of illustration only and are not intended to limit the scope of the teachings.

### BRIEF DESCRIPTION OF THE DRAWINGS

The present teachings will become more fully understood from the detailed description, the appended claims and the accompanying drawings, wherein:

FIG. 1 is an exemplary schematic view of a recreational and/or utility vehicle showing a vehicle management system constructed in accordance with the present teachings;

FIG. 2 is another exemplary schematic view of the vehicle management system constructed in accordance with the present teachings;

FIG. 3 is a side view of a motorcycle showing an exemplary vehicle management system constructed in accordance with the present teachings;

FIG. 4 is a side view of a snowmobile showing an exemplary vehicle management system constructed in accordance with the present teachings;

FIG. 5 is a side view of an all-terrain vehicle showing an exemplary vehicle management system constructed in accordance with the present teachings;

FIG. 6 is a side view of a utility vehicle showing an exemplary vehicle management system constructed in accordance with the present teachings;

FIG. 7A is a schematic of an exemplary self-configuring vehicle management system having a vehicle identifier in accordance with the present teachings;

FIG. 7B is a schematic of alternative exemplary self-configuring vehicle management system having a vehicle identifier in accordance with the present teachings;

FIG. 8 is a schematic of an exemplary self-configuring module based on the vehicle identifier in accordance with the present teachings; and

FIG. 9 is a flowchart showing an exemplary start-up sequence for the vehicle management system in accordance with the present teachings.

### DETAILED DESCRIPTION

The following description of the various embodiments is merely exemplary in nature and is in no way intended to limit the teachings, their application, or uses.

As used herein, the term module and/or device may refer to an application specific integrated circuit (ASIC), a digital and/or analog electronic circuit, a processor (shared, dedicated or group) and memory that executes one or more software or firmware programs, a combinational logic circuit or other suitable electronic and/or mechanical components, which may provide the described functionality.

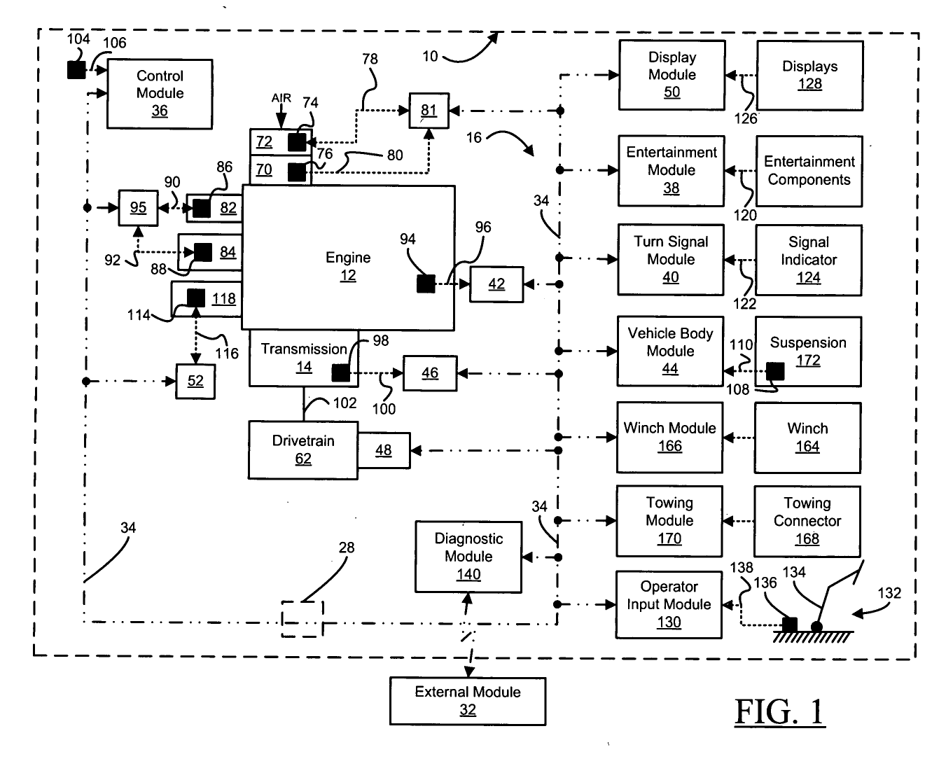

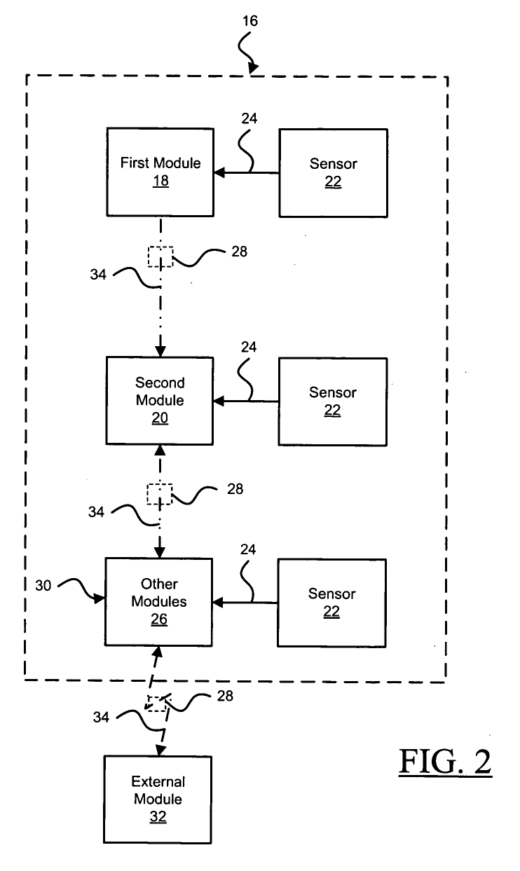

With reference to FIG. 1, a vehicle 10 includes an engine 12, a transmission 14 and a vehicle management system 16. In one simplified example and with reference to FIG. 2, the vehicle management system 16 may include a first module 18 and a second module 20. One or more sensors 22 may communicate respective sensor signals 24 to the first module 18, the second module 20 and/or other modules 26. With reference to FIGS. 1 and 2, each of the sensors 22 may generate one or more of the sensor signals 24 indicative of a value of a parameter, which may be based on the vehicle 10, the engine 12, ambient conditions, etc. The first module 18, the second module 20, and/or other modules 26 may receive the sensor signals 24. The modules 18, 20, 26 may exchange module messages 28 based on the sensor signals 24.

In one example, the modules 18, 20, 26 may include one or more internal modules 30 (FIG. 2) (i.e., within the vehicle) and/or one or more external modules 32. The external module 32 may connect with one or more of the internal modules 30 using wired and/or wireless connections such as the internet, direct connection and other forms of communication such as using electromagnetic waves.

In one example, the sensor signals 24 may define discrete values that may be received, for example, as a voltage. By way of the above example, the voltage (or change therein) may be indicative of a value (or change therein) of a vehicle parameter e.g., a vehicle speed (or acceleration). The voltage may also be indicative of a condition of the vehicle (or change therein) e.g., a headlight on or off. In one example, the sensors signals 24 are a continuous and analog signal.

In one example, the first module 18, the second module 20, and/or the other vehicle modules 26 may exchange the module messages 28 (i.e., discrete digital messages) via a digital system bus 34. Each of the messages 28 may be specifically addressed to one or more of the modules 18, 20, 26 such that all (or some) of the modules 18, 20, 26 may detect (i.e., read) the message 28. Only the modules 18, 20, 26 to which the message 28 is specifically addressed, however, will accept the message 28. The system bus 34 may use a controller area network (CAN) protocol, which also may be specified as International Standards Organization standard 11898. The digital system bus 34 my use (or form) a single-wire, a twisted pair, a two-wire connection, a three-wire connection, a fiber optic connection or other suitable types of hardware and combinations thereof.

In one example and with reference to FIG. 1, a control module 36 communicates with at least the engine 12 and/or the transmission 14. The first module 18 may define the control module 36 and may be, for example, a vehicle computer. The first module 18, the second control module 20 and/or the other vehicle modules 26 may each define, but are not limited to, one or more of the following modules: an entertainment module 38, a turn signal module 40, an engine module 42, a vehicle body module 44, a transmission module 46, a drivetrain module 48, a display module 50, an emission module 52, and/or combinations thereof. It will be appreciated that some (or all) of the above listed modules may be used (singularly or in combination) with the vehicle management system 16. The above-listed modules may also be combined such that a single module may have the combined functionality of two or more of the above listed modules, e.g., combining the transmission module 46 and the drivetrain module 48.

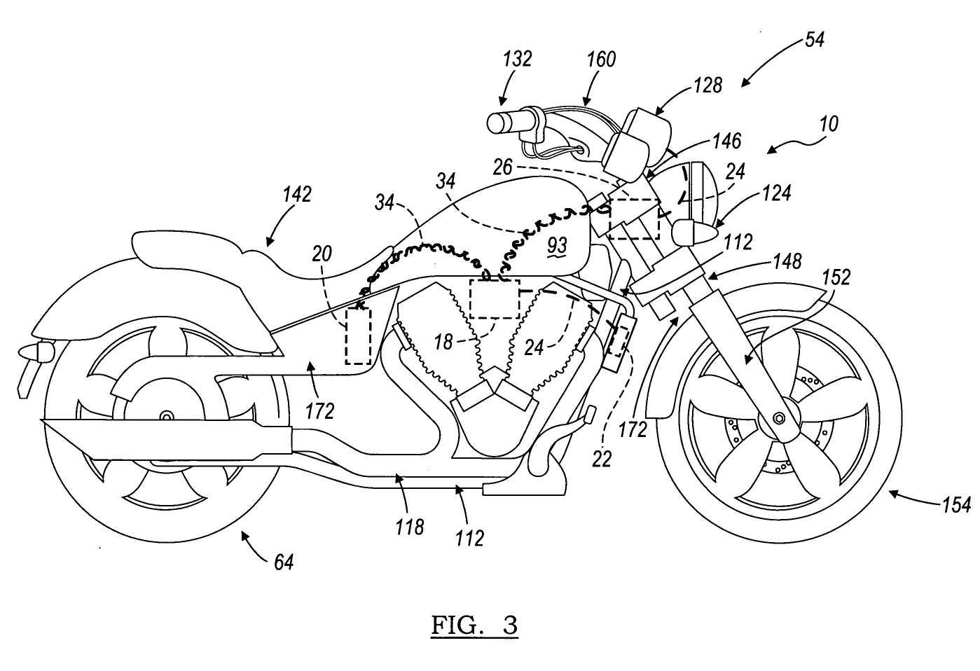

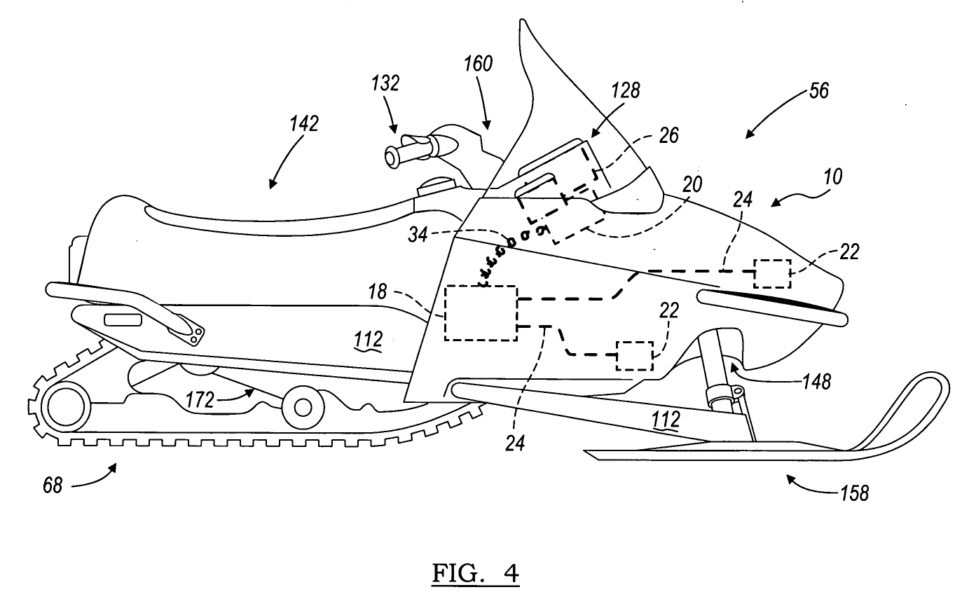

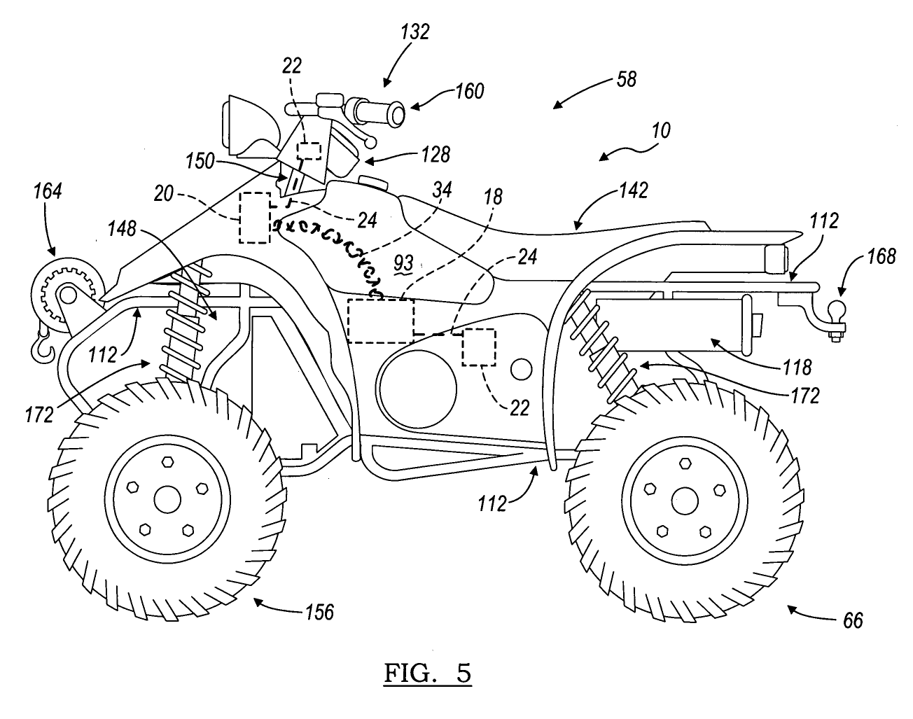

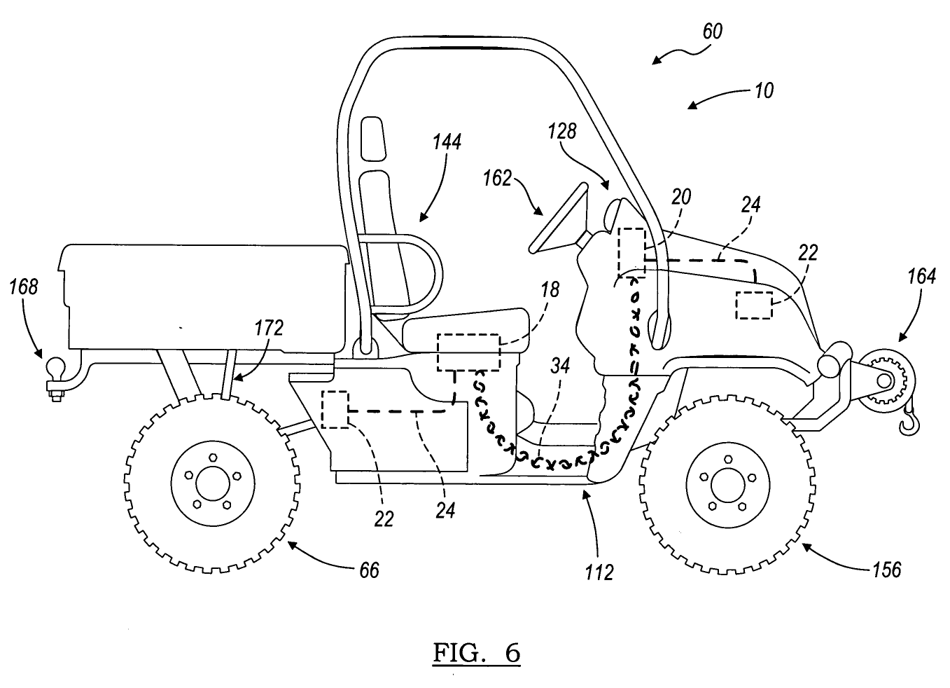

In one example and with reference to FIGS. 1 and 3-6, the vehicle management system 16 may be used with many different vehicles. The vehicle 10 may define a motorcycle 54 (FIG. 3), a snowmobile 56 (FIG. 4), an all-terrain vehicle 58 (FIG. 5), a utility vehicle 60 (FIG. 6) and/or other suitable vehicles.

In one example, the engine 12 and the transmission 14 may provide a torque output via a drivetrain 62. The drivetrain 62 may connect to a single driven wheel 64 (FIG. 3), two or more driven wheels 66 (FIGS. 5 and 6), one or more rotating tracks 68 (FIG. 4), and/or other suitable mechanisms that contact the ground, water and/or air to propel the vehicle 10. It will be appreciated that the engine 12 may define one or more internal combustion engines (with or without a throttle), one or more electric motors, other suitable torque-generating machines and/or combinations thereof.

The engine 12 ingests air through an intake manifold 70 that is regulated by a throttle 72. A throttle sensor 74 and an intake manifold sensor 76 may generate a throttle sensor signal 78 and an intake manifold sensor signal 80 respectively. The control module 36, an intake module 81 and/or other modules may receive the signals 78, 80 and may broadcast one more module messages 28 on the system bus 34 based on the signals 78, 80. The throttle sensor signal 78 may be based on the position of the throttle 72 (or control the throttle 72 to the position) and the intake manifold signal 80 may be based on a manifold pressure from which an engine load may be determined.

A fuel system 82 and/or an ignition system 84 may regulate combustion and thus power output from the engine 12. A fuel system sensor 86 and/or an ignition sensor 88 may generate a fuel system signal 90 and an ignition signal 92 respectively. The control module 36, a fuel system module 95, the engine module 42 and/or other modules receive at least the respective signals 90, 92 and may broadcast one more module messages 28 on the system bus 34 based on at least the signals 90, 92. The fuel system signal 90 may be based on a signal from a fuel pressure sensor, a fuel flow rate sensor, a fuel tank level in a fuel tank 93, an engine vacuum sensor or other suitable sensors and combinations thereof. The ignition signal 92 may be based on coil sensors, distributor sensors, battery sensors, other suitable sensors and combinations thereof.

An engine sensor 94 may generate an engine signal 96. The control module 36, the engine module 42 and/or other modules may receive at least the engine signal 96 and may broadcast one more module messages 28 on the system bus 34 based on at least the signal 96. The engine signal 96 may be based on at least one of an engine speed (e.g., revolutions per minute), a crankshaft angular position, an engine phase, engine coolant temperatures, an oil pressure sensor, an oil temperature sensor, a cylinder head temperature sensor, an exhaust gas oxygen concentration sensor, a camshaft position, other suitable parameters and combinations thereof.

A transmission sensor 98 may generate a transmission signal 100. The control module 36, the transmission module 46 and/or other modules may receive at least the transmission signal 100 and may broadcast one more module messages 28 on the system bus 34 based on the signal 100. The transmission signal 100 may be based on a crankshaft angular position, a transmission output speed, a transmission gear position sensor, transmission fluid temperature, other suitable parameters and combinations thereof. The transmission output speed may define the rotational velocity of a transmission output shaft 102. It will be appreciated that a speed of the vehicle 10 may be determined based on the transmission 14, the drivetrain 62 and/or a speed of the transmission output shaft 102. In one example, the transmission 14 may be a continuously-variable transmission. In a further example, the transmission 14 may be a toroidal-type continuously-variable transmission.

An ambient conditions sensor 104 may generate an ambient condition signal 106. The control module 36 and/or other modules may receive the ambient condition signal 106. The control module 36 (or other modules) may broadcast one more module messages 28 on the system bus 34 based on at least the signal 106. The ambient condition signal 106 may be based on an ambient temperature, an ambient humidity, an ambient pressure, other suitable parameters and combinations thereof.

A body sensor 108 may generate a body signal 110. In one example, the control module 36, the body module 44 and/or other modules receive the body signal 110 and may broadcast one more module messages 28 on the system bus 34 based on at least the signal 110. The body signal 110 may be based on position indicators (e.g., potentiometers) connected to one or more structural members 112 that may form a frame or unit body (FIGS. 3-6) of the vehicle 10.

An emissions sensor 114 may generate an emission signal 116. In one example, the control module 36, the emissions module 52 and/or other modules receives at least the emissions signal 116 and may broadcast one more module messages 28 on the system bus 34 based on at least the signal 116. The emissions signal 116 may be based on oxygen concentration sensor and signal therefrom. The oxygen concentration sensor may connect to the exhaust system 118.

In one example, the vehicle 10 and the vehicle management system 16 may include the entertainment module 38. The entertainment module 38 may communicate one or more entertainment signals 120 to and/or from the following entertainment components: a digital video disc player, a video compact disc player, an audio compact disc player, a digital tape player, a radio, a navigation system, a satellite radio, an intercom, a citizens' band radio, an active noise cancellation system. The entertainment module 38 and/or other modules may broadcast one more module messages 28 on the system bus 34 based on at least the entertainment signal 120. The modular messages 28 from the entertainment module 38 may include, but are not limited to the following messages: volume up button pressed, volume down button pressed, volume mute button pressed, tune up button pressed, tune down button pressed, source/exit button pressed, push-to-talk button pressed, squelch up button pressed, squelch down button pressed, COM/ICOM button pressed, skip/seek CD tracks, skip CD discs, fast forward tape, rewind tape, satellite radio tune up/down, other suitable messages and combinations thereof.

In one example, the vehicle 10 and the vehicle management system 16 include the turn signal module 40. The turn signal module 40 and/or other modules may receive (or generate) one or more turn signals 122 to and/or from a turn signal mechanism (e.g. a stalk or foot buttons) and may broadcast one more module messages 28 on the system bus 34 based on at least the turn signal 122. The turn signal module 40 and/or other modules may accordingly illuminate a turn signal indicator 124 based on the module message 28.

In one example, the vehicle 10 and the vehicle management system 16 may include the display module 50. The display module 50 and/or other modules may generate one or more display signals 126 that may be received by one or more displays 128 connected to the vehicle 10. The display signals 126 may be based on the module messages 28 and one or more sensor signals 24 and indicate for example vehicle speed, engine speed, fuel level, battery level, etc.

The vehicle 10 and the vehicle management system 16 may include an operator input module 130. One or more operator inputs 132 (e.g., an accelerator pedal, grip and/or lever 134) may have an operator input sensor 136 that detects a position of the operator input 132. The operator input sensor 136 may generate an operator input signal 138 indicative of the position of the operator input 132. The operator input module 130 and/or other modules may receive the operator input signal 138 and may generate one or more of the module messages 28 based on the operator input signal 138.

The vehicle 10 and the vehicle management system may include a diagnostic module 140. The diagnostic module 140 and/or other modules may connect with one or more of the external modules 32 and may exchange one or more module messages 28 on the system bus 34 based on one or more suitable diagnostic routines and, as such, form a diagnostic link therebetween. The external module 32 may define a diagnostic tool that directly connects (i.e., a hard wire connection) to the one or more modules on the system bus 34. In another example, the external module 32 may define a remote diagnostic tool that wirelessly connects (i.e., electromagnetic wave communication) to the one or more modules on the system bus 34. In a further example, the external module 32 may define a diagnostic tool that connects to the one or more modules on the system bus 34 via the internet.

With reference to FIGS. 3-6, the vehicle 10 includes one or more structural members 112 that may define the frame and/or the unit body. A saddle seat 142 (FIGS. 3, 4 and 5), a bench seat and/or a full-back seat 144 (FIG. 6) may connect to one or more of the structural members 112. The vehicle 10 also includes the engine 12 and the transmission 14 that may also couple to one or more the structural members 112.

In one example, one or more of the structural members 112 may define a steering assembly journal 146 (FIG. 3). By way of the above example, a front steering assembly 148 may rotatably couple with the steering assembly journal 146. In one example, the front steering assembly 148 includes a steering wheel shaft 150 (FIG. 5) that is rotatably coupled to said steering assembly journal 146. In a further example, the front steering assembly defines a front fork assembly 152 (FIG. 3) rotatably coupled to the steering assembly journal 146. In one example, the front steering assembly 148 couples to a single front wheel 154 (FIG. 3). In an additional example, the front steering assembly 148 couples to a pair of front wheels 156 (FIGS. 5 and 6). In yet another example, the front steering assembly 148 may couple to a pair of skis 158 (FIG. 4). In one example, the steering assembly 148 includes handlebars 160 (FIGS. 3-5). The handlebars 160 are operable to change the direction of the vehicle 10. In one example, the handlebars 160 may be configured to form a steering wheel 162.

In one example, the vehicle 10 includes a winch 164. The vehicle management system 16 may include a winch module 166. The winch module 166 may operate winch 164 based on the module messages 28 received by the winch module 166. The vehicle 10 may include a towing connector 168 that communicates with a towing module 170. The towing module 170 may operate the towing connector 168 (e.g., activate lights and/or brakes) based on the module messages 28 received by the towing module 170.

The vehicle 10 may have one or more suspension components 172 that may connect, for example, the drivetrain 62 to one or more the structural members 112. It will be appreciated that the suspension components 172 and components connected thereto may move relative to the structural members 112. The body sensors 108 may send body signals 110 based on movement of the suspension components 172 to the body module 44.

In one example, the vehicle 10 has a dry weight that is less than about two thousand pounds (about 900 kg). The dry weight is defined as the weight of the vehicle 10 minus any operational fluids such as fuel, oil and/or coolant.

In the above examples, various modules 18, 20, 26 may be used, not used, or replaced in the vehicle 10 by easily removing the module 18, 20, 26 from the system bus 34. As modules 18, 20, 26 are replaced and/or swapped, connection of the modules 18, 20, 26 only requires a simple connection to the system bus 34, thus providing modularity of the vehicle management system 16. It will be appreciated that a new module and/or newly configured module may simply be connected to the system bus 34. The new module has access to all of the module messages 28 broadcast on the system bus 34 without interfering with the existing modules on the system bus 34 or the vehicle management system 16.

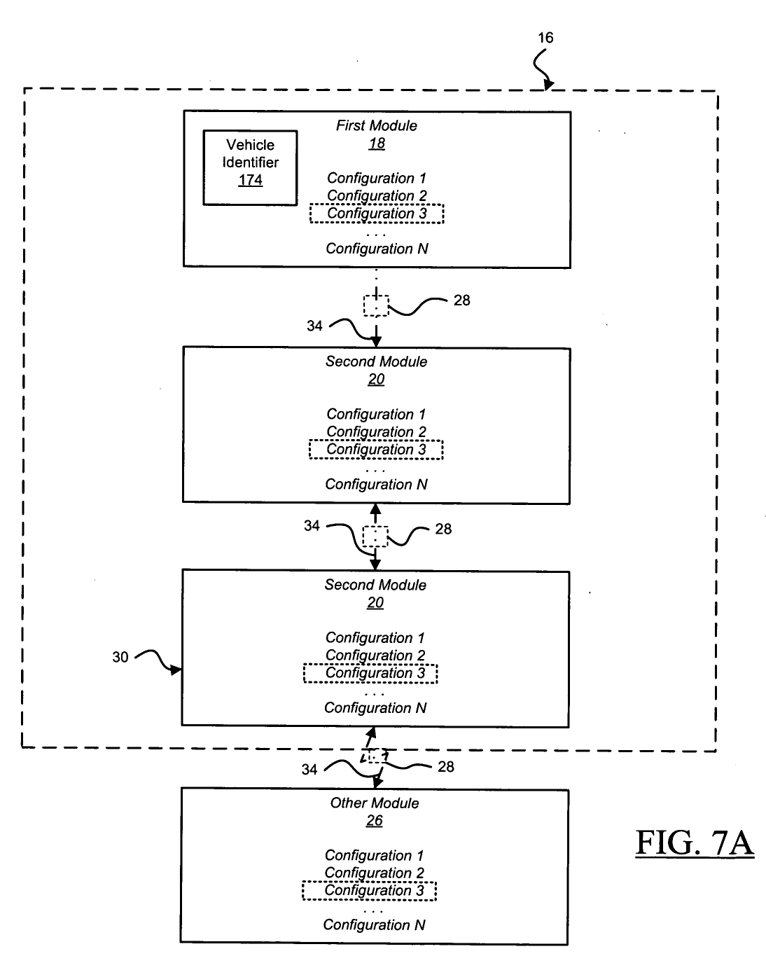

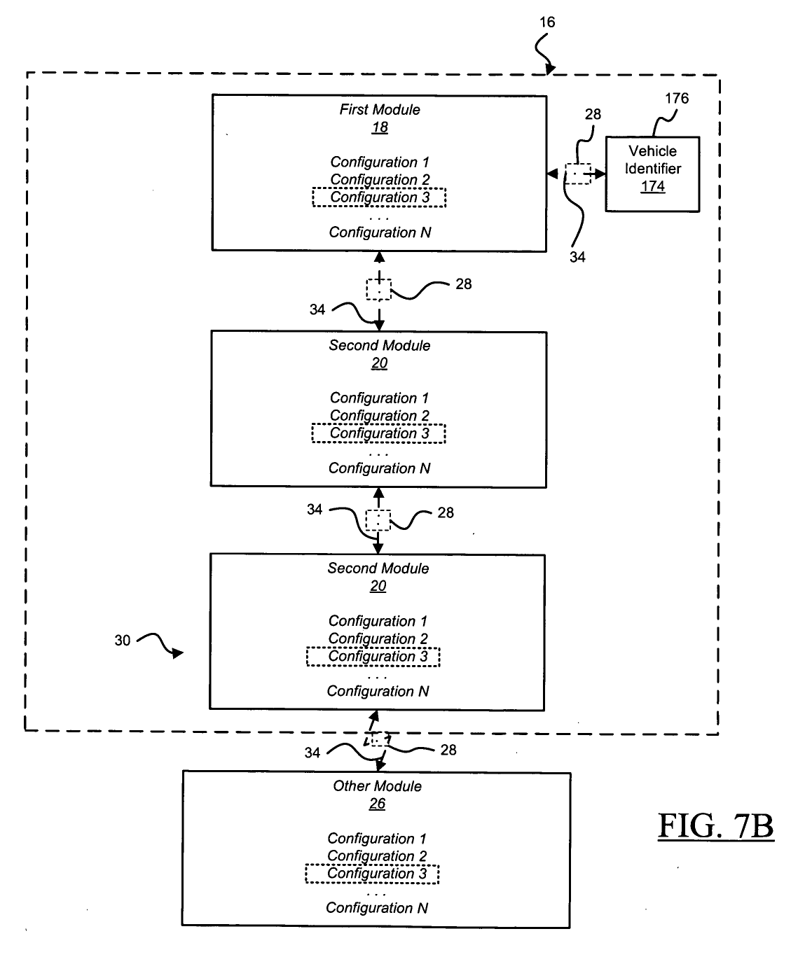

In one example and with reference to FIGS. 7A and 7B, the engine module 42 (FIG. 1) or other suitable module may contain a vehicle identifier 174. The vehicle identifier 174 may include a number and/or other alphanumeric characters that is, for example, based on a vehicle type. The vehicle type may define a unique vehicle configuration that may include, for example, certain engine configurations, certain vehicle configurations, other certain suitable parameters and combinations thereof. The vehicle identifier 174 may be a unique identifier that corresponds to an engine type used with the vehicle 10. For example, the vehicle identifier 174 may identify a snowmobile 56 (FIG. 4) having a two-stroke, two-cylinder engine. In other examples, the engine identifier 174 may be the unique identifier that corresponds to trim levels or other optional features of the vehicle.

The vehicle identifier 174 may be located in the engine module 42, a vehicle identification module 176 (FIG. 7B), and/or any other suitable modules. By way of the above examples, the vehicle identifier 174 is accessible to any and/or all of the modules located on the system bus 34. More specifically, each module may determine (i.e., acquire) the vehicle identifier 174 and thus configure itself based on the vehicle identifier 174.

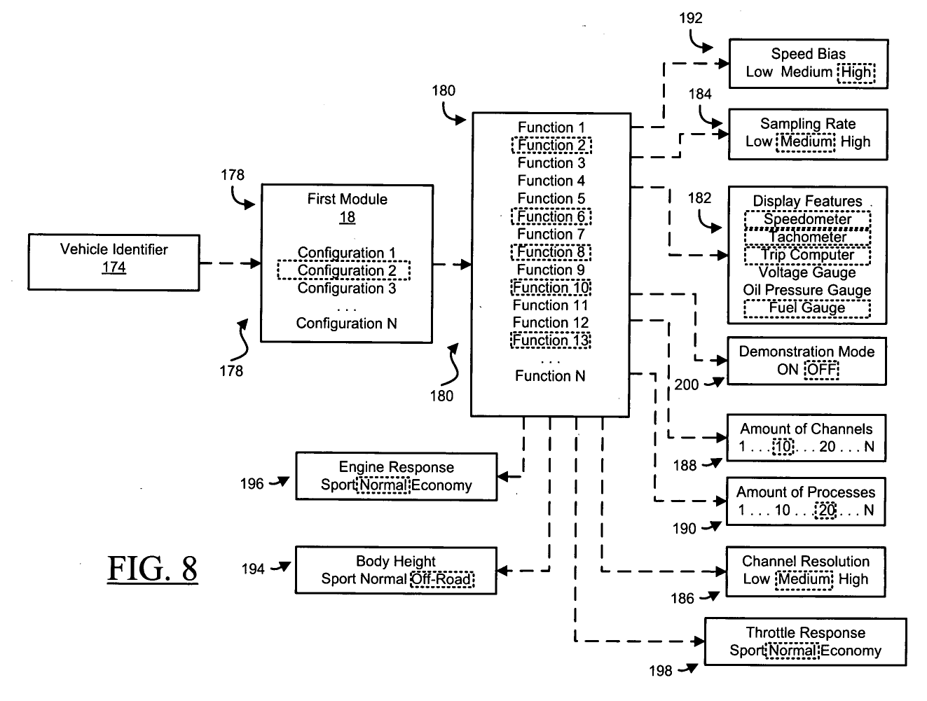

With reference to FIG. 8, one or more of the modules may use (or change to) a certain configuration based on the system identifier 174. In one example, the first module 18 may have a plurality of configurations 178. Each of the modules may also have a plurality of functions 180. For example, a third configuration 178 may correspond to a first subset of functions 180, while a second configuration 178 may correspond to a second subset of functions 180. For example, the first module 18 may have twenty individual functions 180. Under the third configuration 178, the first module 18 may use thirteen of the twenty functions 180. Under the second configuration 178, the first module 18 may use fifteen of the functions 180. The functions used (or activated) under the third configuration and under the second configuration may be the same or different (i.e., there may be overlapping functions activated between certain configurations). As illustrated, the active configuration, function and specific feature are shown boxed by dashed lines. While a specific configuration having a specific subset of used functions that correspond to a specific set of used (or activated) features is shown and indicated by the dashed boxes, it will be appreciated that a plurality of combinations of functions and features are possible that correspond to a plurality of configurations.

In one example, the display indicator 182 may have a plurality of features that correspond to the functions 180 of the certain configuration 178 of the first module 18. One feature may include a trip computer. Other features may include a tachometer, a speedometer, a fuel gauge, an oil pressure gauge, a battery voltage gauge, an engine coolant temperate gauge and/or other suitable display indicators and/or gauges. Based on the vehicle identifier 174, a certain configuration is determined and a subset of one or more of the above functions or other suitable functions may be used (or activated). For example, the engine identifier 174 may correspond to a first configuration, which activates only two functions that support a tachometer and a speedometer. A different vehicle identifier 174 may have the display module 50 to use a second configuration. The second configuration may activate the following functions to support the following features: the speedometer, the tachometer, the trip computer and the battery voltage gauge. It will be appreciated that one or more functions of the first module 18 may be activated (or deactivated) to support one or more features available on (or in) the vehicle 10. In the second configuration, for example, the trip computer feature may not be used and thus certain functions 180 that correspond to the trip computer feature may be deactivated (or not used).

In one example, one function of the plurality of functions of the modules may include a sampling rate 184, a channel resolution 186, an amount of channels 188, and an amount of processes 190. Other functions may include, but are not limited to memory allocation, clock rates, switching frequencies, bit rates, etc. It will be appreciated that various functions and/or features of the vehicle 10 may demand that one or more of the modules adjust one of the above functions (e.g., increase a sampling rate).

By acquiring (i.e., reading) the vehicle identifier 174, the configuration of one or more of the modules may be adjusted such that one or more of the above functions and/or features may be adjusted accordingly. For example, based on a vehicle identifier 174, the sampling rate of one or more channels (i.e., inputs) of one ore more of the modules may be adjusted (e.g., from high to medium to low etc.) to a higher sampling rate to accommodate the additional functionality of one or more of the modules. When additional modules are added to the system bus, the added module may read the vehicle identifier 174 and configure itself accordingly.

In one example, an external module 32 (FIG. 2) may be a remote diagnostic tool, which may connect to the vehicle 10 (FIG. 1). The external module 32 may acquire (read) the vehicle identifier 174 and self-configure based on the identifier 174. For example, the diagnostic tool may determine the configuration and associated functions and/or features of one or more of the modules based on the vehicle identifier and thus only run diagnostics based on the activated functions of each module.

In one example, a speed bias 192 of the vehicle 10 may be adjusted (e.g., from high to medium to low etc.) based on the vehicle identifier 174. The speed bias 192 may, for example, cause the speed indicated on the speedometer to be higher than an actual ground speed. Other modules, however, may depend on an actual speed (not affected by the speed bias) and as such one or more modules may be adjusted based on the system identifier 174 to read the actual speed and/or display the altered speed by the speed bias.

The vehicle identifier 174 may be configured via software and/or hardware. For example, the vehicle identifier 174 may be stored in read-only memory (ROM) within one or more of the modules (e.g., the vehicle identifier module 176 or the engine module 42) via a software configuration. In another example, the vehicle identifier 174 may be set via jumpers and/or dip switches via a hardware configuration associated with one or more of the modules. In either configuration, the vehicle identifier 174 remains accessible to one or more of modules on the system bus 34.

The vehicle identifier 174 may be programmed at the same facility where the vehicle is assembled. The vehicle identifier 174 may be configured such that changes to the vehicle identifier 174 may only be made by the vehicle manufacturer. In some instances, the vehicle manufacturer may make available updates to the vehicle identifier 174 and configuration of the modules based thereon to various authorized service facilities. For example, a service facility may reprogram the vehicle identifier 174 (e.g. re-flash the ROM) when an update of the corresponding software and/or hardware becomes available.

In one example, one or more of the modules may be adjusted to implement or adjust a body height 194, an engine response 196, a throttle response 198 and/or a vehicle demonstration mode 200. The throttle response 198, the engine response 196, and/or body height 194 may include utilizing one or more functions and/or features on one or more of modules based on the vehicle identifier 174. The ride height, engine and/or throttle response may include, but are not limited to, adjusting shift patterns, active aerodynamics, suspension stiffness, etc.

The vehicle identifier 174 may correspond to a certain demonstration mode 200. In the demonstration mode 200 (i.e., demonstration mode on), the vehicle speed, the throttle and/or the engine, shift patterns, etc. may be limited and/or adjusted. The demonstration mode may be used for test-drives, loaners, training vehicles and/or other suitable uses where the full performance of the vehicle may be limited.

In one example, the vehicle types may be based on different engine configurations, such that the vehicle identifier 174 is unique to a certain type of engine (e.g., four-stroke versus two-stroke, one cylinder versus two cylinder, etc.). The vehicle type may also be unique to a type of vehicle, for example, a snow mobile 56 (FIG. 4), a motorcycle 54 (FIG. 3), etc. In further examples, the vehicle type may be unique to limited edition vehicles, custom components installed in (or on) the vehicle and/or other suitable features.

In this regard, a module having the plurality of functions may be installed in multiple vehicles and in multiple vehicle types. In each vehicle and/or vehicle type, the module may self-configure based on the vehicle identifier 174. Because one module with the plurality of functions may be installed, for example, in complete product line a savings may be realized in purchasing a single module. Specific modules per specific vehicle types are no longer needed and the module having the plurality of functions that self-configures per the vehicle identifier may serve the entire (or portions of the) product line (i.e., multiple vehicle types, engines, options etc.).

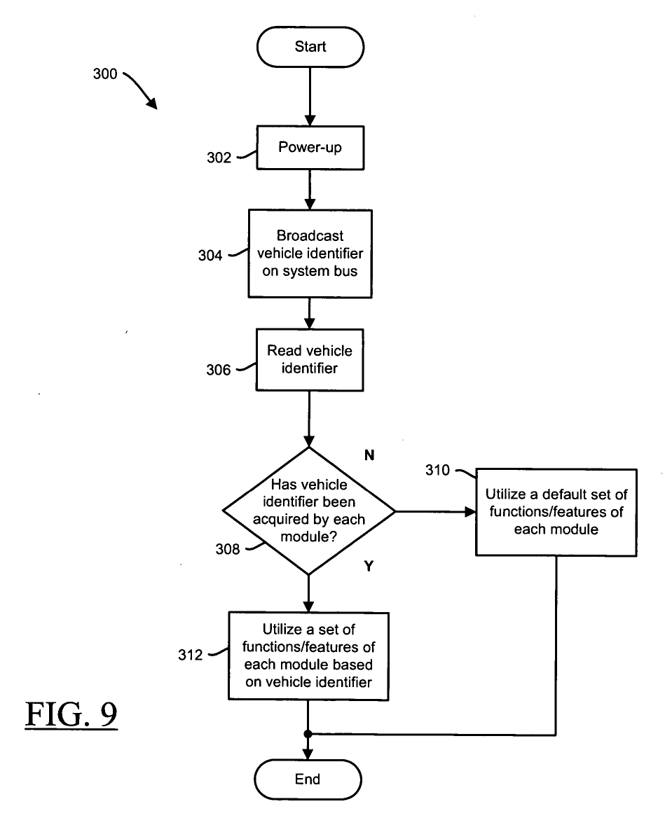

In one example and with reference to FIG. 9, an exemplary start-up sequence 300 is illustrated in accordance with present teachings. In step 302, the vehicle 10 is powered-up, which for example may include turning an ignition key to an on position, turning on an ignition system, etc. In step 304, the vehicle identifier 174 (FIGS. 7A and 7B) is broadcast on the system bus 34 (FIG. 1). The vehicle identifier 174 may be integral to the first module 18 (FIGS. 7A and 7B) and may be included in a separate module, for example the vehicle identifier module 176 (FIGS. 7A and 7B).

In step 306, one or more modules may read the vehicle identifier 174 (FIGS. 7A and 7B) from the system bus 34 (FIG. 1). In step 308, one or more of the modules may determine that the vehicle identifier 174 has not been received. The module may be configured to seek (i.e., listen) for the vehicle identifier 174 for a predetermined period (e.g., thirty seconds). When the module determines that the vehicle identifier 174 has not been received, the sequence 300 continues with step 310. When the module determines that the vehicle identifier 174 has been received, the sequence 300 continues with step 312.

In step 310, the module utilizes (e.g., activates or deactivates) a default (or saved) set of functions and/or features because the module is unable to read (or acquire) the vehicle identifier 174 (FIGS. 7A and 7B). The default set of functions and/or features may define that all functions and/or features are used or a portion thereof. In addition, the module may report (or retain) an error code corresponding to the inability to read the vehicle identifier 174. From step 310, the sequence ends. In step 312, the module utilizes (e.g., activates or deactivates) a set of above-described functions and/or features based on the vehicle identifier 174. From step 312, the sequence ends.

Those skilled in the art can now appreciate from the foregoing description that the broad teachings may be implemented in a variety of forms. Therefore, while the teachings have been described in connection with particular examples thereof, the true scope of the teachings should not be so limited because other modifications will become apparent to the practitioner upon a study of the drawings, the specification and the following claims.

What is claimed is:

1. A vehicle management system comprising:
a first module having a plurality of functions;
a second module;
a system bus, wherein at least said first module and said second module communicate on said system bus; and
an identifier based on one of a plurality of vehicle types, wherein when a first vehicle type is identified a first set of said plurality of functions is utilized based on said identifier associated with said first vehicle type and wherein when a second vehicle type is identified a second set of said plurality of functions is utilized based on said identifier associated with said second vehicle type.

2. The vehicle management system of claim 1 wherein said first set of said plurality of functions includes at least one function not included in said second set of said plurality of functions.

3. The vehicle management system of claim 1 wherein one of said plurality of vehicle types is selected from a group consisting of vehicle models, vehicle types, vehicle configurations, vehicle accessories, vehicle drivetrains, vehicle engines, vehicle options and combinations thereof.

4. The vehicle management system of claim 1 wherein said first module adjusts at least one of said plurality of functions in said first set, wherein said adjusting of one of said functions includes adjusting at least one of an amount of channels, an amount of processes, a sampling rate, a resolution, a speed bias, a throttle response, an engine response, body height, indicators on a display and combinations thereof.

5. The vehicle management system of claim 1 wherein one of said plurality of vehicle types corresponds to an engine configuration.

6. The vehicle management system of claim 1 further comprising an external module adapted to diagnose the vehicle, said external module having a plurality of functions, wherein a first set of said plurality of functions associated with said external module are utilized based on said identifier associated with said first vehicle type and wherein a second set of said plurality of functions associated with said external module are utilized based on said identifier associated with said second vehicle type.

7. The vehicle management system of claim 1 wherein said identifier is integral to said first module or separate from said first module and connected thereto via said system bus.

8. The vehicle management system of claim 1 wherein said first module is selected from a group consisting of an engine controller, a body controller, a transmission controller, a powertrain controller, a display, an emissions controller, a towing module, a winch module, an operator input module, an entertainment module, a turn signal module and combinations thereof.

9. A vehicle management system for a plurality of vehicle types, the vehicle management system comprising:
a first module having a plurality of functions;
a system bus, wherein at least said first module and a second module communicate on said system bus; and
an identifier based on one of the plurality of vehicle types, wherein said first module at least one of
adjusts a function of said plurality of functions,
activates a first set of said plurality of functions,
deactivates a second set of said plurality of functions and combinations thereof based on said identifier.

10. The vehicle management system of claim 9 wherein said first module adjusts at least one of said plurality of functions in said first set, wherein said adjusting of one of said functions includes adjusting at least one of an amount of channels, an amount of processes, a sampling rate, a resolution, a speed bias, a throttle response, an engine response, body height, indicators on a display and combinations thereof.

11. The vehicle management system of claim 9 wherein said identifier is integral to said first module or separate from said first module and connected thereto via said system bus.

12. The vehicle management system of claim 1 wherein said first module is selected from a group consisting of an engine controller, a body controller, a transmission controller, a powertrain controller, a display, an emissions controller, a towing module, a winch module, an operator input module, an entertainment module, a turn signal module and combinations thereof.

13. A recreational or utility vehicle such as a motorcycle, an all-terrain vehicle, utility vehicle or a snowmobile, said vehicle comprising:
a structural member;
a saddle seat connected to said structural member;
an engine that provides a torque output, said engine disposed within an area defined by said structural member;
a suspension system connected to said structural member, wherein a portion of said suspension system is moveable relative said structural member;
a plurality of sensors, at least one of said sensors operable to detect a parameter associated with said engine and operable to generate a signal indicative thereof;
a first module operable to receive at least said signal;
a second module; and
a system bus, wherein said system bus is operable to provide communication between said first module and said second module.

14. The vehicle of claim 13 wherein said system bus is configured as a controller area network.

15. The vehicle of claim 13 further comprising an engine diagnostic link that communicates with said system bus via a direct connection or a wireless connection.

16. The vehicle of claim 13 wherein said plurality of sensors is selected from a group consisting of a throttle position sensor, an oil pressure sensor, an oil temperature sensor, a cylinder head temperature sensor, an exhaust gas oxygen concentration sensor, an intake air temperature sensor, an manifold absolute pressure sensor, an engine coolant temperature sensor, a crankshaft position sensor, a camshaft position sensor, a vehicle ground speed sensor, a fuel pressure sensor, a fuel flow rate sensor, a transmission gear position sensor and combinations thereof.

17. The vehicle of claim 13 wherein said second module is an entertainment system that includes components selected from a group consisting of a digital video disc player, a video compact disc player, an audio compact disc player, a digital tape player; a radio, a navigation system, a satellite radio, an intercom, a citizens' band radio, an active noise cancellation system.

18. The vehicle of claim 13 wherein said system bus includes at least one of a wire connection forming a single wire, a twisted pair, a two-wire connection, a three-wire connection, a fiber optic connection and combinations thereof.

19. The vehicle of claim 13 wherein said second module is selected from a group consisting of an engine controller, a body controller, a transmission controller, a powertrain controller, a display, an emissions controller, a towing module, a winch module, an operator input module, an entertainment module, a turn signal module and combinations thereof.

20. The vehicle of claim 13 further comprising a pair of skis coupled to said suspension system or four wheels coupled to said suspension system.

21. A recreational or utility vehicle such as a motorcycle, an all-terrain vehicle, a utility vehicle or a snowmobile, said vehicle comprising:
a structural member defining a steering assembly journal;
a front steering assembly coupled to said steering assembly journal;
an engine that provides a torque output, said engine coupled to said structural member;
a plurality of sensors, at least one of said sensors operable to detect a parameter associated with said engine and operable to generate a signal indicative thereof;
a first module operable to receive at least said signal;
a second module; and
a system bus, wherein said system bus is operable to provide communication between said first module and said second module.

22. The vehicle of claim 21 wherein said front steering assembly forms a steering wheel shaft rotatably coupled to said steering assembly journal.

23. The vehicle of claim 21 wherein said front steering assembly forms a front fork rotatably coupled to said steering assembly journal.

24. The vehicle of claim 21 wherein said front steering assembly couples to a single wheel.

25. The vehicle of claim 21 wherein said front steering assembly couples to a pair of wheels.

26. The vehicle of claim 21 wherein said front steering assembly couples to a pair of skis or to two tires.

27. A system comprising:
an open-air vehicle having an engine connected to a structural member;
a steering assembly having handlebars, said steering assembly operable to change the direction of the vehicle;
a plurality of sensors, at least one of said sensors operable to detect a parameter associated with said engine and operable to generate a signal indicative thereof;
a first module operable to receive at least said signal;
a second module; and
a system bus, wherein said system bus is operable to provide communication between said first module and said second module.

28. The system of claim 27 wherein said open-air vehicle has a dry weight that is less than about 2000 lbs (about 900 kilograms).

29. The system of claim 27 wherein said handlebars form a steering wheel.

30. The system of claim 27 wherein said second module defines a winch module that operates a winch connected to the structural members.

31. A vehicle management system comprising:
a first module;
an external diagnostic module having a plurality of functions;
a system bus, wherein at least said first module and said external diagnostic module communicate on said system bus; and
an identifier based on one of a plurality of vehicle types, wherein when a first vehicle type is identified a first set of said plurality of functions is utilized based on said identifier associated with said first vehicle type and wherein when a second vehicle type is identified a second set of said plurality of functions is utilized based on said identifier associated with said second vehicle type.

32. A vehicle management system comprising:
a first module having a plurality of functions;
a second module;
a system bus, wherein at least said first module and said second module communicate on said system bus; and
an identifier based on one of a plurality of vehicle types, wherein when a first vehicle type is identified a first set of said plurality of functions is utilized based on said identifier associated with said first vehicle type, when no vehicle type is identified a second set of said plurality of functions is utilized based on a default set of said plurality of functions.
